(19) United States
(12) Patent Application Publication
(10) Pub. No.: US 2005/0226798 A1
(43) Pub. Date: Oct. 13, 2005

(54) Oxygen sorbent compositions and methods of using same

(75) Inventors: Martin Bulow, Basking Ridge, NJ (US); Jurgen Boer, Nordhausen (DE); Wolfgang Burckhardt, Hermsdorf (DE); Hans Ulrich Guth, Greifswald (DE); Helmut Ullmann, Freital (DE); Vladimir V. Vashook, Dresden (DE)

Correspondence Address: The BOC Group, Inc.;Legal Services-Intellectual Property, 575 Mountain Ave., Murray Hill, NJ, 07974, US

(73) Assignee: THE BOC GROUP, INC., Murray Hill, NJ (US)

(21) Appl. No.: 11/005,408

(22) Filed: Dec. 6, 2004

Related U.S. Application Data
(60) Provisional application No. 60/531,780, filed on Dec. 22, 2003.

(51) Int. Cl. B01J 23/10

(52) U.S. Cl. 423/263; 502/328; 502/302

(57) ABSTRACT

Compositions and methods useful for oxygen sorption and other uses are presented, the compositions being within the general formulas (1), (2), (3), and (4):
AₓB_{y}O_{3-δ}, (1)
AₓA′_{x′}B_{y}B′_{y′}O_{3-δ}, and (2)
AₓA′_{x′}A″_{x″}B_{y}B′_{y′}B″_{y″}O_{3-δ}, (3)
MOₙ (4) and combinations thereof, especially those where the B sites are independently selected from cations of the d block transition metals Cr, Mn, Fe, Co, Ni, and Cu. One desirable set of compositions of the invention are combinations of any one or more of the compounds of generals formulas (1), (2), or (3) with one or more compounds of the general formula (4). In combination with an active support or matrix oxide within general formulas (1), (2), and (3), stability of the binary metal oxides within general formula (4) can be enhanced, while extending the oxygen sorption/desorption capacities of the matrix oxide.

### CROSS-REFERENCE TO RELATED APPLICATIONS

This application claims priority from U.S. provisional application No. 60/531,780, filed Dec. 22, 2003, which is incorporated herein by reference in its entirety.

### BACKGROUND OF THE INVENTION

1. Field of the Invention

The invention is generally related to the field of oxygen sorbent materials.

2. Related Art

Materials having the ability to absorb oxygen are useful in many industries, for example enrichment of oxygen from air or other multicomponent fluid. One useful class of crystalline materials is the so-called mixed ionic-electronic conductors (MIEC). These materials have exhibited enhanced sorption, as well as enhanced ionic and electronic conductivities, particularly their oxide-ion mobility and oxygen-(O₂)-storing capacities. High-temperature non-stoichiometric defects (such as oxide-ion vacancies or interstitial oxygen sites) in the crystal lattice allow the materials to temporarily absorb oxygen at high temperature for oxygen enrichment of gas streams, as well as for catalytic transformations of other compounds using the oxygen that is temporarily absorbed.

Potential applications of MIEC materials have been documented: production of syngas and H₂; partial oxidation of light hydrocarbons; production of pure O₂ (with a view toward replacing, possibly, cryogenic distillation); production of O₂-enriched gas mixtures; various environment-related solutions; and solid-oxide fuel cells and sensors (cf, for example, P. J. Gellings and H. J. M. Bouwmeester, Solid State Electrochemistry, CRC Press, Boca Raton, 1996; H. Ullmann, Keramische Zeitschrift, 53 (2001) 100-107; S. J. Skinner and J. A. Kilner, materialstoday (March 2003) 30-37. Specifically, Ion-Transport-Membrane (ITM) technologies for O₂ separation and syngas production are under quickly progressing development.

Technologies other than ITM, such as cyclic high-temperature sorption-desorption processes based on O₂ partial-pressure swings, have gained considerable interest. Cyclic O₂-recovery processes that utilize specific ceramic materials, such as K₂NiF₄ as sorbent/catalyst having high-temperature non-stoichiometric defects are being developed. These processes are referred to as ceramic autothermal recovery processes, or CAR processes, to be discussed further in the Description. They consist of alternately passing air and another medium (or applying vacuum) through pellets or granules of the material in a fixed-bed configuration, with cycle times of the order of minutes or less. Oxygen retained in the solid material during the air-contacting step is released by decrease in O₂-partial pressure via application of vacuum, steam, carbon dioxide, steam-carbon dioxide mixtures, flue-gas mixtures or other appropriate means, to generate an O₂-enriched stream, which is used as feed to other systems, into which CAR could be integrated, e.g., combustion processes.

Key advantages of CAR over ITM processes are ease of material fabrication, plant design and process execution using traditional unit operations. Preliminary estimates indicate significant economic benefits compared to the traditional cryogenic air separation, due to lower energy consumption. On the other hand, cryogenic air separation plants are well understood and, despite their high operating costs, industry momentum is geared toward designing these plants cost-effectively, and this leads to reduced engineering and design costs, and inherent safety built up over time.

One of the key technical issues and risks of the CAR process for O₂ enrichment relates to material development. Of the MIEC materials of interest, perovskites and perovskite-like materials have attracted attention in the past. The process-related crystal-structure oxide-ion, O²⁻, deficiency can be exemplified by perovskite-type oxides, which originally referred to the mineral CaTiO₃. Today, “perovskite” denotes a series of oxygen-containing compounds with a unique general crystal structure, ABO₃, with high-temperature O²⁻ vacancies, denoted by the symbol δ, which obeys the general formula ABO_{3-δ}. The “A”-site cations can be rare earth, alkaline earth, alkaline and other large cations such as Pb²⁺, Bi³⁺, or Ce⁴⁺, and the “B”-site cations can be 3d, 4d, or 5d transition-metal cations. Multiple cation-type occupations of those two sites are possible. Framework sites “A” and “B” are dodecahedral and octahedral, respectively, cf., L. G. Tejuca and J. L. Fierro, Properties and Applications of Perovskite-type Oxides, Marcel Dekker, New York, 1993.

A standard cubic high-temperature perovskite phase remains stable and reversible with regard to changes of 6 within a certain range: The value δ could be as high as 0.25, but as a rule δ=0.05-0.25 (although higher values have been reported), at elevated temperature and low oxygen partial pressure, ie., δ is a function of temperature and partial pressure of oxygen. On the other hand, perovskite stability is governed by cation radii of lattice metals in various valence states combined into a parameter “t” called “tolerance factor”, cf., Z. Shao, et al., Sep. Purif Technol., 25 (2001) 419-42. A perovskite structure can only be formed if t ranges from 0.75-1. These circumstances have set limits to the performance potential of perovskites in O₂-recovery and related processes. Tereoka et al. described the material La₁₋ₓSrₓCo_{1-y}Fe_{y}O_{3-δ} as a medium for oxide-ion permeation with excellent performance at high temperature (Y. Tereoka et al., Chemistry Letters, (1985) 1367-1370; 1743-1746). In this case, the O₂ permeation is driven by the O₂-partial-pressure difference between the two sides of the membrane, and it results from oxygen-ion transport through the vacant sites in the lattice structure. Significant efforts have been directed to the investigation of the fabrication and utilization of these materials as O₂-transport membranes for gas separation and reaction. Mazanec, et al., (U.S. Pat. No. 4,933,054) were awarded a patent in this area in 1990. One recent study of SrCo_{0.4}Fe_{0.6}O_{3-δ} reported, however, a decrease in oxygen permeability through samples that were purposely made stronger by addition of up to 9 wt % ZrO₂, where the Zr⁴⁺ cations replaced some of the B site cations (Yang, et al., Effect of the Size and Amount of ZrO₂ Addition on Properties of SrCo_{0.4}Fe_{0.6}O_{3-δ}, AIChE Journal, Vol. 49, Issue 9, pages 2374-2382 (2003)).

Desorption of O₂ from La₁₋ₓSrₓCoO_{3-δ} was studied and reported by Nakamura et al. (Chemistry Letters, (1981) 1587-1581) in 1981. Later, Teraoka et al. (Chemistry Letters, (1985) 1367-1370) examined O₂ sorption properties of La₁₋ₓSrₓCo_{1-y}Fe_{y}O_{3-δ}. They observed that considerable amount of O₂ was desorbed from this class of oxides as temperature was increased from 300° C. to 1100° C., and was absorbed as temperature was decreased. Mizusaki et al. (J. Solid State Chemistry, 80 (1989) 102) measured the oxygen non-stoichiometry of the perovskite-type oxide La₁₋ₓSrₓCoO_{3-δ} as function of temperature, Sr content (x) and O₂-partial pressure. Lankhorst and Bouwmeester (J. Electrochem. Soc., 144 (1997) 1268) measured the oxygen non-stoichiometry of La_{0.8}Sr_{0.2}CoO_{3-δ}. Zeng and Lin (Solid State Ionics, 110 (1998) 209-221) investigated O₂-sorption and desorption rates of a La_{0.2}Sr_{0.8}CoO_{3-δ} sample subjected to sudden changes of O₂-partial pressure at constant temperatures. They found that this rate could be correlated to a linear-driving force of the deviation of oxygen-vacancy concentration in the bulk phase of the sample from its corresponding thermodynamically equilibrated one.

Few patents have been issued for processes using the O₂-sorption properties of perovskite-type oxides for gas separation and purification. Doi et al., KoKai Patent No. Hei 5(1993)-4044, 1993) disclose using a perovskite-type oxide, ABO_{3-δ}, as high-temperature O₂ sorbent to remove O₂-containing impurities, such as NOₓ by means of a TSA technique to regenerate the sorbent. A Chinese patent application by Yang, et al., Appl. No. 99 1 13004.9, describes a material, Ba_{0.5}Sr_{0.5}SCo_{0.8}Fe_{0.2}O_{3-δ}, with very high concentration of oxygen vacancies. The CAR concept, developed by Lin, et al., U.S. Pat. No. 6,059,858, also uses perovskite-type oxides as sorbents to separate O₂ from an O₂-containing stream, particularly air, by a type of mixed TSA-PSA process. This patent also discloses methods of sorbent regeneration using CO₂ or steam as the purge gas.

U.S. Pat. No. 6,143,203 describes CAR technology extended to the area of hydrogen and synthesis-gas production using perovskite-type oxide sorbents. See also U.S. Pat. Nos. 6,379,586 and 6,464,955. A material patent of common assignment hereto has also been applied for: Supported Perovskite-Type Oxides and Methods for Preparation Thereof by Zeng, et al., U.S. Pub. Pat. Appl., US 2002/0179887 A1 (2002).

As mentioned, the ability of perovskite and perovskite-like materials to function as commercial sorbents has limits. There have been recent efforts to improve the O₂-sorption performance of these materials, but with limited success. U.S. Pat. No. 6,772,501 discloses composites of metals and ion conductors; U.S. Pat. No. 6,740,441 discloses using perovskites to thin-film coat “current collects” (metal screens or mesh) in solid oxide fuel cells, and other devices, and gas separations are mentioned; U.S. Pat. Nos. 6,641,626 and 6,471,921 disclose MIEC conducting membranes for hydrocarbon (HC) processing, and disclose ceramic membranes which have good ionic and electrical conductivity, plus excellent strength under reactor operating conditions. The compositions comprise a matrix of MIEC (especially brownmillerite) with one or more second crystal phase, non-conductive, which enhances strength; U.S. Pat. No. 6,541,159 discloses O₂-separation membranes having an array of interconnecting pores and an OH⁻ ion conductor extending through the pores, and an electrical conductor extending through the pores, discrete from the OH⁻ ion conductor; U.S. Pat. No. 6,440,283 discusses forming pellets, powders, and two-layer structures of La/Sr oxides; U.S. Pat. No. 6,146,549 discloses La/Sr ceramic membranes for catalytic membrane reactors with high ionic conduction and low thermal expansion; U.S. Pat. Nos. 5,509,189 and 5,403,461 discuss solid solutions of pyrochlore crystal phase and perovskite crystal structures.

Despite improvements in the art, the need remains for compositions, which take better advantage of the excellent O₂-sorption and permeability properties of perovskites and perovskite-like materials and with still further enhanced O₂-sorption ability, while exhibiting enhanced durability, so that the materials may be used commercially.

### SUMMARY OF THE INVENTION

In accordance with the present invention, compositions, composites, and methods of use are presented which reduce or overcome many of the problems of previously known materials.

A first aspect of the invention relates to compositions of matter, specifically crystalline ceramic oxide compositions comprising at least one compound within general formulas (1), (2), (3), and (4):
AₓB_{y}O_{3-δ}, (1)
AₓA′_{x′}B_{y}B′_{y′}O_{3-δ}, and (2)
AₓA′_{x′}A″_{x″}B_{y}B′_{y′}B″_{y″}O_{3-δ}, (3)
MOₙ (4)
and combinations thereof, wherein:
A, A′, and A″ are independently selected from ions of atoms having atomic number ranging from 57-71, inclusive, a cation of yttrium, ions of Group 1 atoms, ions of Group 2 atoms, and combinations of two or more, where Group 1 and Group 2 refer to the periodic table of elements;
B, B′, and B″ are independently selected from d-block transition-metal ions selected from Mn, Cr, Fe, Co, Ni, and Cu;
x, x′, x″, y, y′, and y″ are each real numbers ranging from 0 to 1.0;
x+x′+x″=0.8-1.0; y+y′+y″=1.0; and δ ranges from about 0.05 to about 0.30;
M is selected from Cu, Co, Ni, Bi, Pb, V, Mn, and Cr; and
n is a real number ranging from 0.5 to 3,
with the provisos that:
   (1) when a Co ion is present at a plurality of B sites, then at least some of the B′ sites are occupied by Fe ions, and at least some of the B″ sites are occupied by Ni ions;
   (2) when a Cu ion is presented at a plurality of B sites, then at least some of the B′ and B″ sites are occupied by one or more of Mn ions, Cr ions and Fe ions;
   (3) when proviso (1) is true, then at least one other compound within general formulas (1), (2), and (3) is present; and
   (4) when a compound MOₙ is present, it is present with at least one compound within general formulas (1), (2), and (3).

One group of compositions of the invention are those wherein A is an ion of atoms having atomic number ranging from 57-71, inclusive; A′ is an Ca, Sr, or Ba ion; and B and B′ are selected from Ni, Co, Mn, Cr and Fe ions.

One desirable set of compositions of the invention are combinations of any one or more of the compounds of generals formulas (1), (2), or (3) with one or more compounds of the general formula (4). Compounds of general formula (4), termed “binary metal oxides” means a single metal element that assumes different oxidation states within the oxygen partial pressure range of the CAR process, enabling the metal oxide to release oxygen at different partial pressures of oxygen in CAR processes. Of the binary metal oxides, MOₙ, M is a metal of the d block transition metals that changes its oxidation state. Metals may be selected from Cu, Co, Ni, Bi, Pb, V, Mn, and Cr, the oxides of which release oxygen by changing their crystal phase or by their reduction up to the metal. In their pure states, the binary metal oxides do not form stable ceramic shapes because of crystal phase transformations. However, in combination with an active support or matrix oxide (perovskites within general formulas (1), (2), and (3)), stability of the binary metal oxides can be enhanced, while extending the oxygen sorption/desorption capacities of the perovskites.

Compositions of the invention may be formed as structured particles having a particle size ranging from about 0.01 to about 100 microns in largest dimension, or ranging from about 0.1 to about 50 microns.

Compositions of the invention may be supported on, or function as a support for, an “active” support selected from porous inorganic materials that are stable at temperatures ranging from about 500 to about 1000° C. In this form the inventive compositions may be referred to as supported crystalline ceramic oxides. “Active”—as that term is used when referring to support or matrix materials—means that even the supporting material acts in the oxygen sorption and transport. Active supports may be selected from compositions within general formulas (1), (2), and (3), and combinations thereof. Other active support materials useful in the invention include apatite compositions.

) Supported crystalline ceramic oxides of the invention may be shaped, structured articles of manufacture, and may have shape selected from beads, pellets, saddles, rings, pyramids, extrudates with any cross sectional shapes with or without holes, honey-combs with uniform channels and monoliths with random porosity and foam structure, and the like. The inorganic support may be a porous inorganic support comprising a plurality of pores, as further described herein.

A second aspect of the invention are methods of separating a gas component from a mixture of gases by either of pressure swing adsorption, thermal swing adsorption, or combination thereof, comprising contacting a gas mixture with a composition (or composite) of the invention. Methods of the invention include converting a light hydrocarbon (C₅ or less) into hydrogen and carbon monoxide by contacting one or more hydrocarbons with a composition of the invention, including reactions of partial oxidation, steam reforming, auto-thermal reforming, and the like, in either batch, semi-continuous, continuous or cyclic operations. The reactions may be carried out in well-known bed-type reaction vessels, where the bed of particles is fluidized, semi-fluidized, or non-fluidized.

Thus, the present invention provides for novel materials and methods of use, specifically modified mixed ionic-electronic conductor (MIEC) materials (either alone or as composites with active oxygen exchange support materials) with enhanced performance in sorption, catalytic processes, and the like. The inventive compositions owe their ionic and electronic conductivities, particularly their oxide-ion mobility and O₂-storing capacities, to high-temperature non-stoichiometric defects such as oxide-ion vacancies—or interstitial oxygen sites—in the crystal-lattice structure of the solids, and also on changed valency states of a selected series of transition metals, which lead to different oxides of one and the same metal. These materials will have strong potential for high-temperature processes that utilize the O₂-storing/releasing properties for purposes of the enrichment of O₂ in gas streams but also for multi-fold catalytic transformations of other compounds. The inventive compositions may also be formed into chemically and mechanically robust ceramic composites such as sorbent and membrane materials with high O₂ capacities (in the case of sorbents) and high O₂ permeation fluxes (in the case of membranes). This enables the design of high-performance structured ceramics of regular or random shapes, allowing for high performance in O₂ enrichment and, at the same time, the ability to withstand the expected operating conditions in large scale plants, and be cost-effective in addition. The inventive compositions and composites may be utilized advantageously for high-temperature CAR-type PVSA and TSA processes (and also for other related applications) to produce substantially pure O_{2,} syngas and H₂ (at small and large scale), as well as O₂ and fuel in integrated process schemes, for example, so-called oxy-fuel processes, power plants, gas turbines, and many other processes.

Further aspects and advantages of the invention will become apparent by reviewing the detailed description of the invention that follows.

### BRIEF DESCRIPTION OF THE DRAWINGS

FIGS. 1 and 2 illustrate graphically the concept of working capacity for sorbent materials of the invention;

FIG. 3 is a schematic representation of a ceramic autothermal recovery process of the invention;

FIG. 4 shows plots of oxygen uptake/release (ml g⁻¹) vs. square root of time (min^{0.5}) for compositions of the invention;

FIG. 4 demonstrates graphically a comparison of sorption isotherms for oxygen between two materials, YBa₂Cu₃O_{7-δ} and La_{0.2}Sr_{0.8}Co0.6Fe_{0.4}O_{3-δ}; and

FIG. 5 shows graphically results of specific CAR experiments over a temperature range, 750 to 850 ° C., as percentage of oxygen in an air-based product gas stream at column outlet with steam as purge gas, as dependence on number of cycles performed.

### DETAILED DESCRIPTION OF THE INVENTION

Novel materials that reversibly deliver O₂ in CAR processes and other methods of use are now described in further detail. Primary attention is paid to new compositions of oxides that act reversibly with high exchange rate and high capacity for O₂ over an O₂-partial pressure region between 5 and 0.01 atmosphere. Beside these parameters, their chemical and long-time mechanical stability under the conditions of commercial processes, with maintenance of both the desired crystal structure and secondary ceramic shape, specifically by considering chemical reaction with gases and thermal expansion coefficients as important material-specific parameters, are accounted for.

One group of compositions of the invention may generally be categorized as perovskite-type compounds within the three general formulas (1), (2), and (3):
AₓB_{y}O_{3-δ}, (1)
AₓA′_{x′}B_{y}B′_{y′}O_{3-δ}, and (2)
AₓA′_{x′}A″_{x″}B_{y}B′_{y′}B″_{y″}O_{3-δ}, (3)
where framework sites “A” are dodecahedral and “B” are octahedral. As mentioned in the background section, a standard cubic high-temperature (about 500-1200° C.) perovskite phase remains stable and reversible with regard to changes of δ within δ=0.05-0.25 at elevated temperature and low oxygen partial pressure. On the other hand, perovskite stability is governed by cation radii of lattice metals in various valence states combined into a parameter “t” called “tolerance factor”, and a perovskite structure can only be formed if t ranges from 0.75-1. These circumstances have set limits to the performance potential of perovskites in O₂-recovery and related processes. Attempts to extend the limits of useful perovskites have failed, at least as far as oxygen permeability is concerned. For example, when a perovskite material was purposely made stronger by addition of ZrO₂, where the Zr⁴⁺ cations replaced some of the B site cations, the material was stronger, however, the oxygen permeability decreased (Yang, et al., Effect of the Size and Amount of ZrO₂ Addition on Properties of SrCo_{0.4}Fe_{0.6}O_{3-δ}, AIChE Journal, Vol. 49, Issue 9, pages 2374-2382 (2003)).
I. Crystalline Ceramic Oxides

A. Perovskite-type Oxides

The inventors herein have discovered that compositions of the invention overcome some or all the limitations of previous compositions in enhancing oxygen permeability and oxygen trapping ability. One set of compositions of the invention are crystalline ceramic oxide compositions comprising one or more compounds within the general formulas:
AₓB_{y}O_{3-δ}, (1)
AₓA′_{x′}B_{y}B′_{y′}O_{3-δ}, and (2)
AₓA′_{x′}A″_{x″}B_{y}B′_{y′}B″_{y″}O_{3-δ}, (3)
and mixtures thereof, wherein:
A, A′, and A″ are independently selected from ions of atoms having atomic number ranging from 57-71, inclusive, a cation of yttrium, ions of Group 1 atoms, ions of Group 2 atoms, and combinations of two or more, where Group 1 and Group 2 refer to the periodic table of elements;
B, B′, and B″ are independently selected from d-block transition metal ions selected from Mn, Cr, Fe, Co, Ni, and Cu;
x, x′, x″, y, y′, and y″ are each real numbers ranging from 0.01 to 1.0;
x+x′+x″ ranges from about 0.8 to about 1.0; y+y′+y″=1.0; and δ ranges from about 0.05 to about 0.30,
with the provisos that:
   (1) when a Co ion is present at a plurality of B sites, then at least some of the B′ sites are occupied by Fe ions, and at least some of the B″ sites are occupied by Ni ions;
   (2) when a Cu ion is presented at a plurality of B sites, then at least some of the B′ and B″ sites are occupied by one or more of Mn ions, Cr ions and Fe ions; and
   (3) when proviso (1) is true, then at least one other compound within general formulas (1), (2), and (3) is present.

As may be seen from the above general description of perovskites of the invention, the key to the effectiveness of these compositions lies in the selection of the B site cations; in particular, it appears that the ability of Fe, Co, Ni, Cu, Cr and Mn cations to be present in more than one oxidation state in the crystal lattice at high temperatures allows, the compositions of the invention to be particularly useful in temporarily absorbing oxygen, especially in certain unexpected combinations of cations. It is also theorized that the ionic radii of the selected cations in their various oxidation states, and the fluctuation between these states and radii, perhaps help in the generation of oxide ion vacancies in the crystal lattice. The valency states of the various transition metals deemed useful in the compositions of the invention, and the ionic radii of the most stable ion, are presented in Table 1, in accordance with R. D. Shannon, Acta Cryst., A32 (1976) 751-767. The ionic and electronic conductivities of these compositions, particularly their oxide-ion mobility, and oxygen-(O₂)-storing capacities that are based on high-temperature non-stoichiometric defects such as oxide ion vacancies, or interstitial oxygen sites, in the crystal-lattice structures of these solids, makes compositions of the invention particularly useful in oxygen separation.

TABLE 1
Valance States and Ionic Radii

| Atomic Number | Symbol | Possible Oxidation States | Ionic radii (pm)* |
|---|---|---|---|
| 24 | Cr | 2, 3*, 4, 5, 6 | 62 |
| 25 | Mn | 7, 6, 4, 3, 2* | 67 |
| 26 | Fe | 2, 3* | 55 |
| 27 | Co | 2*, 3 | 65 |
| 28 | Ni | 2*, 3 | 69 |
| 29 | Cu | 2*, 1 | 73 |

*Most stable cation

Perovskite crystalline ceramic oxides of the invention may be those wherein A is an ion of atoms having atomic number ranging from 57-71, inclusive; A′ is an Sr ion; and B and B′ are selected from Ni, Co and Fe ions. Perovskite crystalline ceramic oxides of the invention may be solid solutions of compounds having the formula LaₓSrₓNi_{y}Co_{y′}Fe_{y″}O_{3-δ} wherein x+x′ ranges from about 0.8 to about 1.0; y+y′+y″ ranges from about 1.0 to about 1.1, and one or more compounds within the general formulas AₓB_{y}O_{3-δ} and AₓA′_{x′}B_{y}B′_{y′}O_{3-δ}, particularly those compositions wherein 0.5<x<1, 0.1<x′<0.5, 0.2<y<0.8, 0.2<y′<0.6 and 0.1<y″<0.5. Some specific perovskite crystalline ceramic oxides of the invention include those in Table 2.

B. Binary Metal Oxides

Compounds of general formula (4) are termed “binary metal oxides”, MOₙ, where M is a metal that changes its oxidation state, and n is a real number ranging from 0.5 to about 3. M is a single metal ion that assumes different oxidation states within the oxygen partial pressure range of the CAR process, enabling the metal oxide to release oxygen at different partial pressures of oxygen in CAR processes. Metals may be selected from Cu, Co, Ni, Bi, Pb, V, Mn, and Cr, the oxides of which release oxygen by changing their crystal phase or by their reduction up to the metal. In their pure states, the binary metal oxides do not form stable ceramic shapes because of crystal phase transformations. However, in combination with an active support or matrix oxide (perovskites within general formulas (1), (2), and (3)), stability of the binary metal oxides can be enhanced, while extending the oxygen sorption/desorption capacities of the perovskites.

A desired set of compositions of the invention are those wherein a perovskite-type compound serves as an active matrix for one or more binary metal oxides. This combination has been shown to increase the extent of oxygen exchange and working capacity of the composite material. Some of these binary oxides are known as catalytic active materials. The concentration of the binary oxide in the composite may range from about 1 to about 50 wt %, or from about 2 to about 20 wt %.

TABLE 2
Crystalline Ceramic Oxides
A. Perovskite-type oxides

La_{0.6}Sr_{0.4}Co_{0.8}Fe_{0.2}O_{3-δ}
Sr_{0.9}Ce_{0.1}Fe_{0.8}Co_{0.2}O_{3-δ}
La_{0.8}Sr_{0.2}Ni_{0.4}Co_{0.4}Fe_{0.2}O_{3-δ}
La_{0.2}Sr_{0.8}Co_{0.6}Fe_{0.4}O_{3-δ}
Ba_{0.5}Sr_{0.5}Co_{0.8}Fe_{0.2}O₃₋ₓ
Ca_{0.5}Sr_{0.5}Mn_{0.8}Fe_{0.2}O_{3-δ}
Ca_{0.45}Sr_{0.45}Mn_{0.8}Fe_{0.2}O_{3-δ}
La_{0.6}Sr_{0.4}Cr₀₂Fe_{0.8}O_{3-δ},

B. Metals of varying valency states and their oxides and related phase
transformations

CuO/Cu₂O/Cu
PbO₂/PbO/Pb
Bi₂O₃/Bi
NiO/Ni
CoO/Co

When more than one crystalline ceramic oxide is present in a composition of the invention, the differing crystalline ceramic oxides may be present in a variety of formats, including, but not limited to, solid solutions, layered compositions, randomly mixed compositions, one crystalline ceramic oxide of the invention overlaid on (or dispersed in) a second crystalline ceramic oxide of the invention, and the like. For example, the two or more perovskite-type crystalline ceramic oxides may be present as intergrown layers, or as discrete layers. As examples of these: La_{0.2}Sr_{0.8}Co_{0.6}Fe_{0.4}O_{3-δ} in alternating or intergrown layers with Sr_{0.9}Ce_{0.1}Fe_{0.8}Co_{0.2}O_{3-δ}; La_{0.6}Sr_{0.4}Co_{0.8}Fe_{0.2}O_{3-δ} in alternating or intergrown layers with La_{0.8}Sr_{0.2}Ni_{0.4}Co_{0.4}Fe_{0.2}O_{3-δ}; La_{0.8}Sr_{0.2}Ni_{0.4}Co_{0.4}Fe_{0.2}O_{3-δ} in alternating or intergrown layers with La_{0.2}Sr_{0.8}Co_{0.6}Fe_{0.4}O_{3-δ}. Multiple layers are possible, with alternating layers of two or more of the inventive crystalline ceramic oxides. These compositions of the invention may be comprised of alternating layers of crystalline ceramic oxides of the invention. In the case of a binary metal oxide in combination with a perovskite of general formula (1), (2), or (3), one desirable set of compositions comprises a binary metal oxide mixed with a perovskite matrix to form a composite with uniform distribution of the minor (binary metal oxide) component in the major perovskite oxide (matrix). Another desired set of composition of the invention are those wherein a perovskite-type compound is overlaid by a binary metal oxide. Such arrangements allow for (i) buffering thermal-mechanical properties, (ii) increasing the surface-reaction rate by enhancing the accessible surface and the influence of grain-boundary region effects, and (iii) synergistic effects for increasing the “working capacity” of the materials.

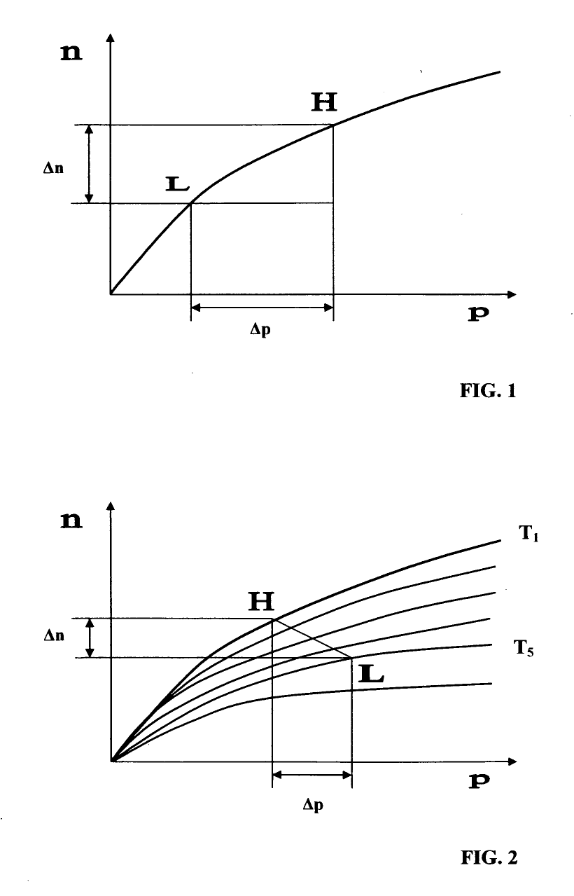

The meaning of the process parameter “working capacity” follows from FIGS. 1 and 2 that illustrate by sorption-isotherm schemes the sorption-process principles TSA (Thermal Swing Adsorption) and PSA (Pressure Swing Adsorption), respectively. A CAR process could be thought to be executed at conditions limited by these two principles. FIG. 1 illustrates graphically a pressure swing adsorption (PSA) scheme. (A similar figure would express a vacuum swing adsorption (VSA) scheme, which those of skill in the art will recognize is another method useful in practicing the invention.) In a PSA scheme, adsorption of the desired species (typically O₂) by pressure build-up at constant temperature leads to point H. Desorption using either pressure decrease (or vacuum) or partial pressure decrease in the desired species (using a replacement or sweep gas) at constant temperature leads the system to point L. The resulting difference is sorption uptake as shown at the ordinate is An over the difference in (partial) pressure Δp. The difference An represents the so-called “working capacity” (or desorbable amount of target species over a defined oxygen partial pressure range). This cycle is typically repeated one or a plurality of times. FIG. 2 illustrates graphically a temperature swing absorption (TSA) scheme. Absorption of the desired species (typically O₂) by pressure build-up at constant temperature T₁ leads to point H. Desorption using temperature increase, e.g., towards T5 with (or without) some pressure increase, leads the system to point L. Desorption may be supported by purge in conjunction with temperature increase using a fluid species that is less strongly sorbed than the target species. The resulting working capacity of the sorbent material is illustrated as the desorbed amount of target species, Δn. This cycle is typically repeated one or a plurality of times.

Crystalline ceramic oxide compositions of the invention may be formed as particles having a particle size ranging from about 0.01 to about 100 microns in the largest diameter, or ranging from about 0.1 to about 50 microns. When a binary metal oxide is present with a perovskite-type compound of the invention, the binary metal oxide may overlay the perovskite-type compound, and the binary metal oxide may have a crystallite size ranging from about 0.1 to about 0.5 microns. The particles may be shaped articles of manufacture, having shape selected from beads, pellets, saddles, rings, pyramids, cubes, extrudates with any cross sectional shapes with or without holes, honey-combs with uniform channels and monoliths with random porosity and foam structure, and the like.

Crystalline ceramic oxide compositions of the invention may be made and characterized using standard ceramic processing steps and equipment. For example, to make La_{0.6}Sr_{0.4}Co_{0.8}Fe_{0.2}O_{3-δ}, one might start with technical grade samples of each rare earth oxide and metal oxide required. Stoichiometric amounts, according to the desired end composition, are well mixed using an agate and pestle. The mixture would then be fired at a high temperature, usually about 1000° C. The as prepared powder is then pressed into the desired shapes under pressure, and then sintered to make the dense material. If a layered structure is desired, such as a binary metal oxide layer overlaying a perovskite matrix, these steps would be repeated with stoichiometric amounts of the desired binary metal oxide being mixed with the crystalline ceramic oxide from the first procedure. The structure of the powder and the final shaped articles may be studied using XRD employing a diffractometer such as that known under the trade designation D/Max-RB, available from Rigaku. Oxygen temperature-programmed desorption equipment is readily available. A heating rate of 10° C./min is typical. Oxygen permeation of membrane materials may be studied using known gas chromatography (GC) techniques. For example, a disk of the sintered material may be sealed in the end of an alumina tube, one side of the disk exposed to air, the other exposed to flowing helium. The outlet gas (He+O₂) is connected to the GC, for example a GC available from Hewlett-Packard known under the trade designation HP5890A. The GC is calibrated frequently using standard gases. The O₂ permeation flux (J_{O2}) may be calculated from known equations, such as the following:
J_{O2}=S/S+×P°×F/Sₘ,
where S is the oxygen area of the outlet gas, S° the oxygen area of the standard gas, P° the percentage of O₂ in the standard gas, F the outlet gas flow rate and Sₘ the effective inner surface area of the membrane material.

Composite Compositions

The crystalline ceramic oxides (perovskite-type oxides, binary metal oxides, and combinations thereof) of the invention may be supported on, or function as a support for, an “active” matrix selected from porous inorganic materials that are stable at temperatures ranging from about 500 to about 1000° C. In this form the inventive composites may be referred to as supported crystalline ceramic oxides, or simply composite compositions, and these materials are particularly well-suited for high-temperature CAR-type processes for O₂ enrichment. Recall that primary compositional changes/doping of basic perovskite-type materials to improve their properties with regard to oxygen exchange have reached their limits. As used herein, the term “composite” means mechanical combinations on a macro scale of two or more solid materials, one of which is a crystalline ceramic oxide of the invention, resulting in compositions with specific goal-oriented macroscopic properties. The phenomenon of building up/using composites allows for significant unexpected (i) additional O₂-exchange capacity; (ii) improved thermo-chemical properties; (iii) appropriate changes in surface-reaction rates; and (iv) improved ceramic-material processing.

Examples of composite compositions of the invention include compositions where the “core” O₂-exchange material and the matrix (support) material are both active with regard to O₂-exchange. For example, composites of this invention include one or more crystalline ceramic oxides of the invention (discussed supra in Section I) combined with an oxygen-exchange active matrix, including an oxide such as another perovskite that is slightly active, but contributes desirable mechanical and thermal properties to the composite. Composites of the invention optionally include a stabilizing component. It is anticipated that for most composites of the invention an appropriate binder will have to be utilized.

The stabilizing component functions to maintain the ability of the composition to undergo repeated cyclic changes in its crystal structure as temperature, pressure, or both are cycled. Suitable stabilizers are rare earth (lanthanides series) elements and their oxides, such as erbium and erbium oxide.

Binders function to maintain the intended physical shape of the composites of the invention under the constraints of the conditions of use. These constraints include chemical, electrical, and mechanical, and suitable binders are materials that substantially match the chemical, electrical, mechanical, and thermo-mechanical properties of the crystalline ceramic oxides and active support materials. In particular for non-membrane CAR extrudates to be used under pressure-swing conditions, the binder should allow composites of the invention to achieve a crush strength of at least about 3 kg/cm², or at least about 5 kg/cm², as tested by specific techniques and criteria the particular features of which depend greatly on both the shape and geometry of the particles investigated. Specifically, “buffering” of the thermal-expansion coefficient at O⁻ deficiency conditions (for crystals) allows for maximum Δδ to be utilized by substantially reducing or eliminating the thermo-mechanical-stress gradient across the CAR-type macroscopic particle. The mechanical strength of composites of the invention under operating conditions may be improved, for example, by choosing appropriate supports, inert fillers, fibers and the like. Suitable binders may or may not be chemically active, and include metal oxides that do not undergo significant change in oxidation state, examples of which include the various aluminas, silicas, titanias and zirconia. These materials are well known in the ceramics art.

Active supports useful in the invention may be perovskite-type oxides within general formulas (1), (2), and (3), and binary metal oxides, in particular binary metal oxides of d-block transition metals and mixtures thereof. The active support may have a particle size (largest dimension) ranging from about 1 to about 10,000 microns, or ranging from about 10 to about 1,000 microns. Supported crystalline ceramic oxides of the invention are shaped articles of manufacture, having shape selected from beads, rings, pyramids, extrudates with any cross sectional shapes with or without holes, honey-combs with uniform channels and monoliths with random porosity and foam structure, and the like.

As with the embodiments of crystalline ceramic oxides of the invention having two or more crystalline ceramic oxide present, composites of the invention may be comprised of alternating and densely packed thin layers of oxygen-exchange active materials. Such arrangements provide for an opportunity to (i) buffer thermal-mechanical properties, (ii) increase the surface-reaction rate by enhancing the accessible surface, and also the influence of grain-boundary region effects, (iii) provide synergistic effects for increasing working capacity of the composite material. For purposes of enhanced rate processes, the compositions of the invention enhance the macroscopic properties that are dependent on reaction rates that are in turn dependent on macro-kinetic properties.

Intimately arranged physical mixtures of crystallographically incompatible compositions of the invention also have utility as dual-compounded composite materials of the invention. For example, one or more crystalline ceramic oxides of the invention may be physically dry mixed with an active matrix material of the type mentioned herein with a suitable binder material.

Specific macroscopic size and system properties of compositions of the invention of physical/physico-chemical nature that have an unexpected strong (positive) influence on enhanced O₂-exchange capacity, including improved thermo-chemical properties and accelerated surface-reaction rate are as follows:

(1) increase in “working capacity” along the O₂-sorption isotherm (by appropriate change of its slope) via mixing effects with additional synergies (for example, enhancement of surface reaction) and by combining O₂-exchange active support materials into composites with crystalline ceramic oxides of the invention, which show differences in their active O₂-partial-pressure regions (select active support materials having high O²⁻ capacity and that may have a linear sorption isotherm in order to ensure an increased ΔO₂ loading, and its utilization under CAR-operating conditions);

(2) doping of the perovskite-type material of the general formula A′ₓA″ₓB′_{y}B″_{y}O₃₋ₓ with all the possible variations in decoding A′, A″, B′, and B″, for several examples, or other materials to vary either the surface-exchange rate for O₂ or the rate of chemical oxide-ion diffusion to allow for a process regime along “non-equilibrium” isotherms, and increasing, thus, the working capacity, even if the total O₂ capacity remains unchanged/comparatively low. Particularly, this could be achieved by decreasing the surface reaction rate at constant high chemical diffusivity (in the crystalline bulk of the exchange-active material);

(3) creating an additional regular macropore-channel system in secondary single-component perovskite and/or composite particles, such as extrudates, pellets, and the like, (cf., W. Geipel and H J. Ullrich, Füllkörper-Taschenbuch, Vulkan Verlag, Essen, 1991; and R. J. Wijngaarden, A. Kronberg, K. R. Westerterp, Industrial Catalysis, Wiley-VCh, Weinheim, 1998) and avoiding formation of mesoporosity with Knudsen-type transport by utilizing auxiliary pore-forming materials, for example, of organic character, in the making of secondary-material shapes that leads to a stochastic macroporosity only. Organic components of sufficient large size, such as naphthalene and/or naphthalene-based compounds, which consist of carbon and hydrogen only, to be burned off completely without strong side reactions, are desirable for this purpose. However, concentration of pore-creating additives has to be balanced with regard to efficient removal of CO₂ formed, which could be detrimental to specific perovskite-type materials;

(4) improving the macro-kinetics of CAR processes by utilizing shape effects in secondary single-component material and/or composite particles (combining these with enhancement factors that stem from the additional regular macropore-channel system.);

(5) create “dispersion effects” on external surfaces of crystalline ceramic oxides or composite particles to enhance the surface-exchange rate;

(6) select crystalline ceramic oxide crystallite size distributions with their maxima shifted toward lower or higher crystal sizes, depending on typical rate processes that have to be identified and characterized for finding composition-specific optima); and

(7) utilize tribochemical and acid-treatment methods to activate external surface-area regions of crystalline ceramic oxides and composites including same for enhancing surface reaction by minimizing the surface barrier.

Two component composites of the invention may vary greatly in terms of ratio of composition of the two components (ratio of mass or volume of core oxygen exchange material to mass or volume of matrix or support material). This ratio may vary from about 1:100 to about 1:20. The particle size for any particular composite of the invention may vary over a large particle size distribution or a narrow particle size distribution, expressed in terms of Gaussian distribution curves.

Composites of the invention are prepared by means known to those of skill in the ceramics art. They may be prepared by dispersing the crystalline ceramic oxides of the invention onto an active support with or without the aid of a liquid solvent, and treating the mixture of ceramic oxide and support at a temperature ranging from about 600 to about 1,500° C. The active inorganic support may be a porous inorganic material comprising a plurality of pores. The porous structure may be formed from a “green” composition comprising additives useful in forming pores in the porous inorganic material and useful to control pore structure of the pores, such as water, organic solvents, celluloses, polymers, synthetic and naturally formed fibers, starches, metal oxides, and the like, and combinations thereof. Additives may be selected from water, cellulose, about 0.1 to 1 wt % MgO and about 0.1 to 0.5 wt % TiO₂. Pore sizes may range from about 0.001 to 10 microns, or from 0.01 to 1 micron, and specific surface area may range from about 1 to 200 m²/g, or range from 1 to 50 m²/g.

Methods of Use

A second aspect of the invention are methods of separating a gas component from a mixture of gases by either of pressure-swing adsorption, thermal swing adsorption, or combination thereof comprising passing a gas mixture through or past a composition or composite of the invention. Methods of the invention include those wherein the sorbed oxygen may then be used in situ for reacting with another compound while still sorbed, or desorbed and subsequently reacted, or combination of these (for example the oxygen may be desorbed from the compositions of the invention contained in a vessel and subsequently reacted, in the same vessel, with a compound to be oxidized). If used in thin membrane form, the compositions of the invention may serve as mixed ion and electron conductors, where oxygen atoms contacting one side of the membrane accept 2 electrons conducted through the membrane to form O²⁻ ions, while a hydrocarbon flows past the other side of the membrane and reacts with O²⁻ ions conducted through the membrane to form CO, H₂ and release 2 electrons. Reactions using the oxygen so sorbed or recovered, such as partial hydrocarbon oxidation, hydrocarbon steam reforming, hydrocarbon auto-thermal reforming, and the like, in either batch, semi-continuous, continuous or cyclic operations, are considered within the invention. Aside from the use of the compositions of the invention in these methods, the methods are themselves known to skilled artisans. For example, the method descriptions in U.S. Pat. Nos. 6,143,203; 6,379,586 and 6,464,955, and U.S. Pub. Pat. Appl., 2002/0179887 A1 are incorporated herein by reference.

Methods of the invention include converting a light hydrocarbon (C₅ or less) into hydrogen and carbon monoxide by contacting one or more hydrocarbons with a particulate composition (or composite) of the invention, carried out in well-known bed-type reaction vessels, where the bed of particles may be fluidized, semi-fluidized, or non-fluidized. Alternatively, membrane configurations may be employed, as discussed above. Partial hydrocarbon-oxidation reactions are advantageous in that they are exothermic, and typically carried out at temperatures ranging from about 600 to about 1200° C. In these temperature regimes, the compositions and composites of the invention are well-suited, since the high-temperature perovskite cubic structure predominates.

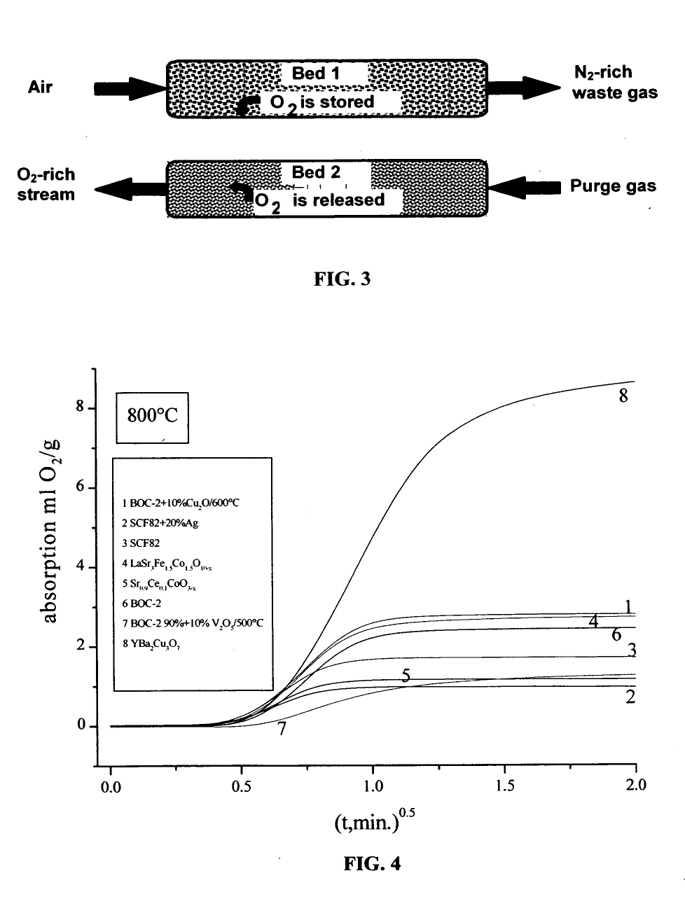

CAR is a Ceramic Auto-thermal Recovery process executed cyclically on conventionally shaped perovskites or related solids in a fixed-bed sorption-type arrangement at high temperature; as a rule at T>600° C. One scheme, illustrated in FIG. 3, illustrates a two-bed system that is run symmetrically. While exothermic sorption uptake of oxygen takes place in Bed 1 by passing air through it with a nitrogen-enriched waste gas leaving the bed, endothermic desorption of oxygen and its release as an oxygen-enriched product gas stream takes place in Bed 2, due to oxygen partial pressure decrease as a result of purging the bed with an inert gas. Appropriate heat management of the process system allows for overall autothermal conditions.

### EXAMPLES

### Example 1

Oxygen sorption-desorption characteristics such as exchange-capacity data was measured by means of a home-built technique that utilized a Lambda sensor for oxygen detection and analysis. The Lambda sensor used was of type LSU 4.2 of the Bosch Company (Germany) with a voltage chosen at 0.6 V. At this voltage, the current does not depend on voltage. Calibration took place with mixtures of dry air and argon to arrive at oxygen concentrations between 1 vol. % and 21 vol. % (air). This resulted in a linear dependence between oxygen concentration in the gas and the current that passes the sensor. The gas flow could be switched between air (oxygen sorption uptake) and argon (with about 10 ppm oxygen-trace content) (oxygen desorption/release). The temperature was kept at 800° C., in all experiments. Gas flow rates were established/measured at 6 l/hr for both air and argon.

Results of these experiments are shown in FIG. 4 as plots of oxygen uptake/release (ml g⁻¹) vs. square root of time (min^{0.5}). For purposes of screening and characterization, a series of mixed oxides of various types were investigated. Without addressing specific details at this instance it could be concluded from these measurements, that the perovskite-type material YBa₂Cu₃O_{7-δ} allows for the highest reversible oxygen uptake at a temperature of 800° C. It exceeded that of the material, La_{0.2}Sr_{0.8}Co_{0.6}Fe_{0.4}O_{3-δ} by a factor of 3 to 4, with a “working capacity” exceeding that of the latter material by a factor of (3-5).

### Example 2

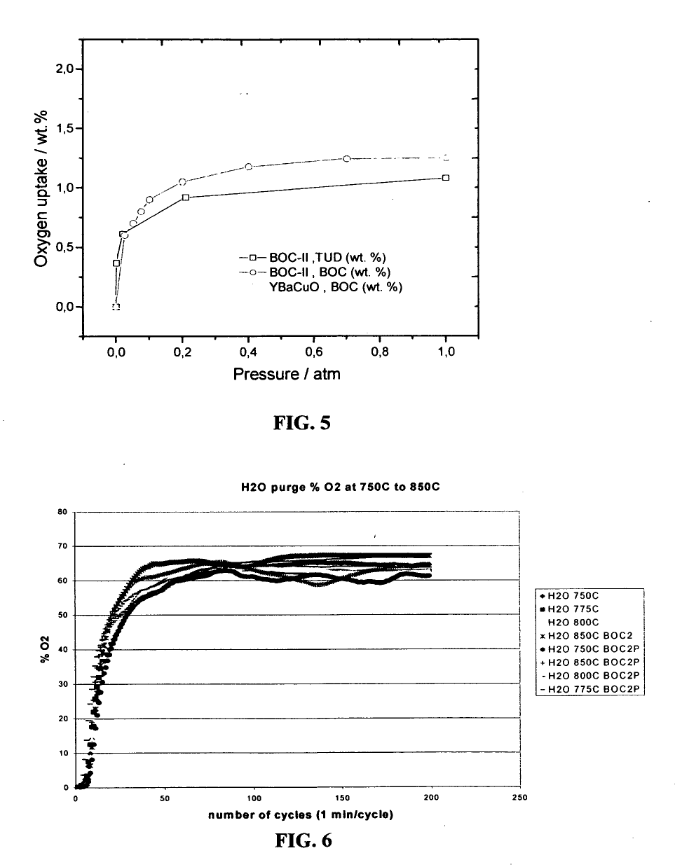

FIG. 5 shows oxygen sorption isotherms measured at 800° C. on two different perovskite compositions, viz., La_{0.2}Sr_{0.8}Co_{0.6}Fe_{0.4}O_{3-δ} and YBa₂Cu₃O_{7-δ}, i.e., plots of oxygen uptake expressed in terms of weight percentage, wt. %, vs. oxygen partial pressure at constant temperature. These isotherms were obtained by means of a home-built high-temperature gravimetric spring-balance technique, the principle of which is described, for example, in F. Rouquerol, J. Rouquerol, K. Sing, “Adsorption by Powders and Porous Solids”, Academic Press, London, 1999, p.60.

FIG. 5 demonstrates sufficiently close oxygen-isotherm-curve courses for the BOC-II materials prepared either in-house (denoted as BOC) or at the Technical University of Dresden (Germany) (denoted as TUD). The material coded as YBaCuO, which stands for a perovskite of the chemical composition YBa₂Cu₃O_{7-δ}, exceeds La_{0.2}Sr_{0.8}Co_{0.6}Fe_{0.4}O_{3-δ} both in its absolute sorption uptake and “working capacity”. A comparison of isotherms for oxygen between these two materials allows to select partial pressure differences as such that the “working capacity”, Δn, on YBaCuO exceeds that of La_{0.2}Sr_{0.8}Co0.6Fe_{0.4}O_{3-δ} by a factor of three, at least.

These results offer several options to enhance CAR-process performance efficiency: (1) reducing sorbent mass and adsorber sizes by about factor 3 if keeping constant all the other process parameters; (2) maximizing the cycling frequency of CAR processes towards their kinetic limits; (3) maximizing yield and specific product of overall processes; (4) minimizing the process temperature.

### Example 3

FIG. 6 shows results of specific CAR experiments over a temperature range, 750 to 850° C., as percentage of oxygen in an air-based product gas stream at column outlet with steam as purge gas, as dependence on number of cycles performed (total length of cycle comprised by sorption and purge steps: 1 min). The air-inlet pressure was set at 780 torr. The flow rate of water purge stream was controlled manually and kept at 7.5 cm³ min⁻¹ in all experiments. The charts show oxygen enrichment by the CAR process performed on three different BOC-II samples of one and the same chemical composition La_{0.2}Sr_{0.8}Co_{0.6}Fe_{0.4}O_{3-δ}; (1) first extrudate batch (no notation), (2) a bead sample (notation: BOC2), (3) a pellet sample (notation: BOC2 P). The sorbent samples are essentially non-porous having a BET-type specific surface area<0.5 m² g⁻¹.

After a start-up period, enrichment leads to nearly constant oxygen levels in the product stream amounting to about 60 to 70 % oxygen (with nitrogen and water as residuals), which are almost independent of both the type of secondary particle shape and process temperature.

### Example 4

A combination of results of Examples 2 and 3 enables to predict a significant increase in oxygen content in product streams based on air as feed gas for the CAR process. This holds for process versions with any type of oxygen partial pressure decrease in order to release oxygen from the bed: either by applying vacuum or purge by either steam or carbon dioxide or by their mixtures, or by other inert gases. In each of those cases, it becomes possible to enable an up-to-three-fold increase in oxygen percentage in the product gas stream. This means that resulting oxygen-enriched gas products would essentially be composed of oxygen only, with traces of nitrogen still retained in the bed and of the purge gas used.

Although the foregoing description is intended to be representative of the invention, it is not intended to in any way limit the scope of the appended claims.

1. A crystalline ceramic oxide composition comprising one or more compounds within general formulas (1), (2), (3), and (4):
AₓB_{y}O_{3-δ}, (1)
AₓA′_{x′}B_{y}B′_{y′}O_{3-δ}, and (2)
AₓA′_{x′}A″_{x″}B_{y}B′_{y′}B″_{y″}O_{3-δ}, (3)
MOₙ (4)
and combinations thereof, wherein:
A, A′, and A″ are independently selected from ions of atoms having atomic number ranging from 57-71, inclusive, a cation of yttrium, ions of Group I atoms, ions of Group 2 atoms, and combinations of two or more, where Group 1 and Group 2 refer to the periodic table of elements;
B, B′, and B″ are independently selected from d-block transition-metal ions selected from Mn, Cr, Fe, Co, Ni, and Cu;
x, x′, x″, y, y′, and y″ are each real numbers ranging from 0 to 1.0;
x+x′+x″ ranges from about 0.8 to about 1.0; y+y′+y″=1.0; and δ ranges from about 0.05 to about 0.30;
M is selected from Cu, Co, Ni, Bi, Pb, V, Mn, and Cr; and
n is a real number ranging from 0.5 to 3,
with the provisos that:
(1) when a Co ion is present at a plurality of B sites, then at least some of the B′ sites are occupied by Fe ions, and at least some of the B″ sites are occupied by Ni ions;
(2) when a Cu ion is presented at a plurality of B sites, then at least some of the B′ and B″ sites are occupied by one or more of Mn ions, Cr ions and Fe ions;
(3) when proviso (1) is true, then at least one other compound within general formulas (1), (2), and (3) is present; and
(4) when a compound MOₙ is present, it is present with at least one compound within general formulas (1), (2), and (3).

2. The composition as claimed in claim 1 wherein A is an ion of atoms having atomic number ranging from 57-71, inclusive; A′ is an Sr ion; and B and B′ are selected from Ni, Co and Fe cations.

3. The composition as claimed in claim 1 which is a solid solution of compounds having the formula LaₓSr_{x′}Ni_{y}Co_{y′}Fe_{y″}O_{3-δ} wherein x, x′, y, y′ and y″ are all smaller than 1.05 but greater than 0, and one or more compounds within the general formulas AₓB_{y}O_{3-δ} and AₓA′_{x′}B_{y}B′_{y′}O_{3-δ}.

4. The composition as claimed in claim 3 wherein 0.5<x<1, 0.1<x′<0.5, 0.2<y<0.8, 0.2<y′<0.6 and 0.1<y″<0.5.

5. The composition as claimed in claim 1 having a particle size ranging from about 0.01 to about 100 microns.

6. The composition as claimed in claim 1 having a particle size ranging from about 0.1 to about 50 microns.

7. The composition as claimed in claim 1 supported on an active support selected from porous inorganic materials that are stable at temperatures ranging from about 500 to about 1000° C.

8. The composition as claimed in claim 7 wherein the active support comprises a perovskite-type compound selected from compounds within general formulas (1), (2), and (3).

9. The composition as claimed in claim 8 wherein the composition is a binary metal oxide within general formula (4) and the active support is a compound within general formulas (1), (2), and (3).

10. The composition as claimed in claim 9 wherein the binary metal oxide has a crystallite size in its largest dimension ranging from about 0.1 to about 5 microns.

11. The composition as claimed in claim 1 wherein said composition is selected from:
La_{0.6}Sr_{0.4}Co_{0.8}Fe_{0.2}O_{3-δ},
Sr_{0.9}Ce_{0.1}Fe_{0.8}Co_{0.2}O_{3-δ},
La_{0.8}Sr_{0.2}Ni_{0.4}Co_{0.4}Fe_{0.2}O_{3-δ},
La_{0.2}Sr_{0.8}Co_{0.6}Fe_{0.4}O_{3-δ},
Ba_{0.5}Sr_{0.5}Co_{0.8}Fe_{0.2}O_{3-δ},
Ca_{0.5}Sr_{0.5}Mn_{0.8}Fe_{0.2}O_{3-δ},
Ca_{0.45}Sr_{0.45}Mn_{0.8}Fe_{0.2}O_{3-δ}, and
La_{0.6}Sr_{0.4}Cr_{0.2}Fe_{0.8}O_{3-δ}, and combinations thereof.

12. The composition as claimed in claim 11 wherein said composition is La_{0.6}Sr_{0.4}Co_{0.8}Fe_{0.2}O_{3-δ}.

13. The composition as claimed in claim 11 wherein said composition is Sr_{0.9}Ce_{0.1}Fe_{0.9}Co_{0.2}O_{3-δ}.

14. The composition as claimed in claim 11 wherein said composition is La_{0.8}Sr_{0.2}Ni_{0.4}Co_{0.4}Fe_{0.2}O_{3-δ}.

15. The composition as claimed in claim 7 wherein said active support has a particle size in its largest dimension ranging from about 1 to about 10,000 microns.

16. The composition as claimed in claim 15 wherein said particle size ranges from about 10 to about 1,000 microns.

17. The composition as claimed in claim 1 which is prepared by dispersing precursors of the composition onto an active support with or without the aid of a liquid solvent; and treating the precursors and support at a temperature ranging from about 600 to about 1,500° C.

18. The composition as claimed in claim 1 supported on an active support to form a supported crystalline ceramic oxide, wherein said supported crystalline ceramic oxide has a shape selected from beads, pellets, saddles, cubes, cylinders, rings, pyramids, extrudates with any cross sectional shapes with or without holes, honey-combs with uniform channels and monoliths with random porosity and foam structure.

19. The composition as claimed in claim 18 wherein the shape is selected from monoliths or extrudates with cylindrical shape.

20. The composition as claimed in claim 7 derived from a green composition comprising additives useful in forming pores in the porous inorganic material and useful to control pore structure of the pores.

21. The composition as claimed in claim 20 wherein said additives are selected from water, organic solvents, celluloses, polymers, synthetic and naturally formed fibers, starches and metal oxides.

22. The composition as claimed in claim 21 wherein said additives are selected from water, cellulose, about 0.1 to 1 wt % MgO and about 0.1 to 0.5 wt % TiO₂.

23. The composition as claimed in claim 7 having pore sizes in the range of about 0.001 to 10 microns, and specific surface area as obtained by the BET method in the range of 1 to 200 m²/g.

24. The composition as claimed in claim 23 having pore size in the range of about 0.01 to 1 micron, and specific surface area as obtained by the BET method in the range of 1 to 50 m²/g.

25. The composition as claimed in claim 1 coated on one or more non-porous support materials to achieve an increase in performance, and enhancement of thermal and mechanical properties of the composition.

26. The composition as claimed in claim 7 formed by extrusion.

27. The composition as claimed in claim 26 wherein said extrusion is performed using screw extrusion methods.

29. The composition as claimed in claim 7 formed by pressing procedures.

30. The composition as claimed in claim 7 formed by granulation procedures.

31. The composition as claimed in claim 1 having a plurality of macroporous channels.

32. The composition as claimed in claim 1 comprising intergrown layers of two or more compounds within general formulas (1), (2), (3), and (4).

33. The composition as claimed in claim 1 comprising stacked layers of two or more compounds within general formulas (1), (2), (3), and (4).

34. A composition comprising:
(A) a matrix comprising a crystalline ceramic oxide composition within the general formula:
AₓA′_{x′}B_{y}B′_{y′}O_{3-δ};
wherein:
A and A′ are independently selected from ions of atoms having atomic number ranging from 57-71, inclusive, a cation of yttrium, ions of Group 1 atoms, ions of Group 2 atoms, and combination of two or more, where Group 1 and Group 2 refer to the periodic table of elements;
B and B′ are independently selected from d-block transition metal ions;
x+x′=1.0; y+y′=1.0; and d ranges from about 0.05 to about 0.30; and
(B) one or more binary metal oxides dispersed on or in said matrix.

35. The composition of claim 34 wherein the crystalline ceramic oxide is selected from:
La_{0.6}Sr_{0.4}Co_{0.8}Fe_{0.2}O_{3-δ},
Sr_{0.9}Ce_{0.1}Fe_{0.8}Co_{0.2}O_{3-δ},
La_{0.8}Sr_{0.2}Ni_{0.4}Co_{0.4}Fe_{0.2}O_{3-δ},
La_{0.2}Sr_{0.8}Co_{0.6}Fe_{0.4}O_{3-δ},
Ba_{0.5}Sr_{0.5}Co_{0.8}Fe_{0.2}O_{3-δ},
Ca_{0.5}Sr_{0.5}Mn_{0.8}Fe_{0.2}O_{3-δ},
Ca_{0.45}Sr_{0.45}Mn_{0.8}Fe_{0.2}O_{3-δ}, and
La_{0.6}Sr_{0.4}Cr₀₂Fe_{0.8}O_{3-δ}, and combinations thereof.

36. The composition of claim 35 wherein the binary metal oxide is selected from compounds within the general formula MOₙ, where M is selected from Cu, Co, Ni, Bi, Pb, V, Mn, and Cr and n is a real number ranging from 0.5 to 3.

37. The composition of claim 34 wherein the crystalline ceramic oxide has particle size in its largest dimension ranging from about 1 to about 10,000 microns and the binary metal oxide has a crystallite size in its largest dimension ranging from about 0.1 to about 5 microns.

38. A method of separating a gas component from a mixture of gases by a process selected from pressure swing adsorption, thermal swing adsorption, or combination thereof comprising contacting said gas mixture with the composition as claimed in claim 1.

39. A method of separating a gas component from a mixture of gases by a process selected from pressure swing adsorption, thermal swing adsorption, or combination thereof comprising contacting said gas mixture with the composition as claimed in claim 11.

40. A method of separating a gas component from a mixture of gases by a process selected from pressure swing adsorption, thermal swing adsorption, or combination thereof comprising contacting said gas mixture with the composition as claimed in claim 12.

41. A method of separating a gas component from a mixture of gases by a process selected from pressure swing adsorption, thermal swing adsorption, or combination thereof comprising contacting said gas mixture with the composition as claimed in claim 34.

42. A method for converting hydrocarbons into hydrogen and carbon monoxide by contacting said hydrocarbons with the composition as claimed in claim 1 having oxygen sorbed thereon.

43. A method for converting hydrocarbons into hydrogen and carbon monoxide by contacting said hydrocarbons with the composition as claimed in claim 11 having oxygen sorbed thereon.

44. A method for converting hydrocarbons into hydrogen and carbon monoxide by contacting said hydrocarbons with the composition as claimed in claim 34 having oxygen sorbed thereon.

45. The method as claimed in claim 42 wherein reactions selected from partial oxidation, steam reforming, or auto-thermal reforming, take place in a mode selected from batch, semi-continuous, continuous or cyclic operations.

46. The method as claimed in claim 44 wherein reactions selected from partial oxidation, steam reforming, or auto-thermal reforming, take place in a mode selected from batch, semi-continuous, continuous or cyclic operations.

47. The method as claimed in claim 44 wherein reactions selected from partial oxidation, steam reforming, or auto-thermal reforming, take place in a mode selected from batch, semi-continuous, continuous or cyclic operations.
